(19) United States
(12) Patent Application Publication
(10) Pub. No.: US 2013/0027261 A1
(43) Pub. Date: Jan. 31, 2013

(54) ANTENNA APPARATUS

(71) Applicant: Wataru Sakurai, Shizuoka-ken (JP)

(72) Inventor: Wataru Sakurai, Shizuoka-ken (JP)

(73) Assignee: TOSHIBA TEC KABUSHIKI KAISHA, Tokyo (JP)

(21) Appl. No.: 13/553,971

(22) Filed: Jul. 20, 2012

(30) Foreign Application Priority Data
Jul. 29, 2011 (JP) 2011-166744

(51) Int. Cl. H01Q 13/20

(52) U.S. Cl. 343/772

(57) ABSTRACT

According to one embodiment, an antenna apparatus comprises a leaky coaxial cable, a first housing, a second housing and a connecting unit. The first housing configured to retain a part of one end of the leaky coaxial cable. The second housing configured to retain a part of other end of the leaky coaxial cable. The connecting unit configured to connect the first housing with the second housing such that the direction of the second housing relative to the first housing can be alerted.

### CROSS-REFERENCE TO RELATED APPLICATION

This application is based upon and claims the benefit of priority from Japanese Patent Application No. 2011-166744, filed Jul. 29, 2011, the entire contents of which are incorporated herein by reference.

### FIELD

Embodiments described herein relate to an antenna apparatus.

### BACKGROUND

For an antenna apparatus using a leaky coaxial cable (LCX) as antenna, it is not allowed to adjust the dimension of a communication range by adjustment of the length of the leaky coaxial cable.

### BRIEF DESCRIPTION OF THE DRAWINGS

FIG. 1 is a perspective view of an antenna apparatus under a first state;

FIG. 2 is a perspective view of the antenna apparatus under a second state;

FIG. 3 is a drawing illustrating the dimension of the communication area under the first state;

FIG. 4 is a drawing illustrating the dimension of the communication area under the second state;

FIG. 5 is a perspective view of the antenna apparatus under a state of a shielding member is fixed.

### DETAILED DESCRIPTION

According to one embodiment, an antenna apparatus comprises a leaky coaxial cable, a first housing, a second housing and a connecting unit. The first housing configured to retain a part of one end of the leaky coaxial cable. The second housing configured to retain a part of other end of the leaky coaxial cable. The connecting unit configured to connect the first housing with the second housing such that the direction of the second housing relative to the first housing can be alerted.

Hereinafter, one example of the embodiment will be illustrated with reference to the drawings.

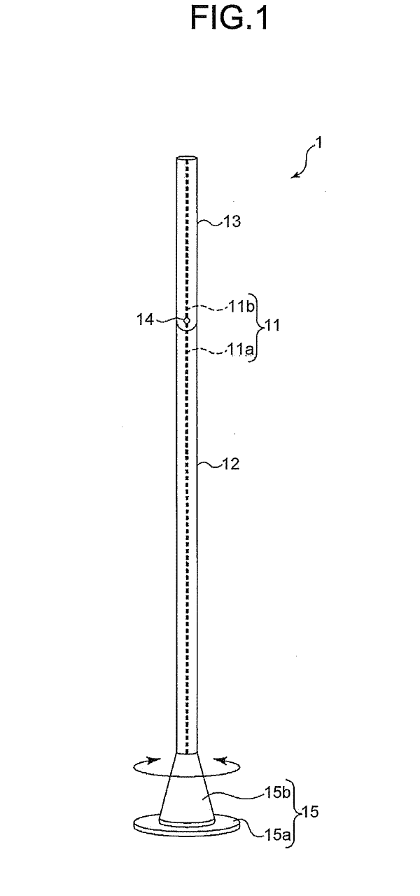

FIG. 1 is a perspective view of an antenna apparatus 1 according to the embodiment.

The antenna apparatus 1 comprises a leaky coaxial cable (LCX) 11, a first housing 12, a second housing 13, a connecting unit 14, and a supporting table 15.

The LCX 11 transmits a high-frequency signal supplied from one end to other end, meanwhile radiates a part of the energy of the high-frequency signal as radio wave from a slot arranged at the middle portion. LCX 11 generates a high-frequency signal depending on surrounding electromagnetic wave.

The first housing 12 forms a hollow cylindrical shape, and its interior space accommodates a first region 11a that is a part of one end of the LCX 11a. The first housing 12 retains the first region 11a in an approximately-linear fashion as shown in FIG. 1.

The second housing 13 forms a hollow cylindrical shape, and its interior space accommodates a second region 11b that is a part of other end of the LCX 11. The second housing 13 retains the second region 11b in an approximately-linear fashion, as shown in FIG. 1.

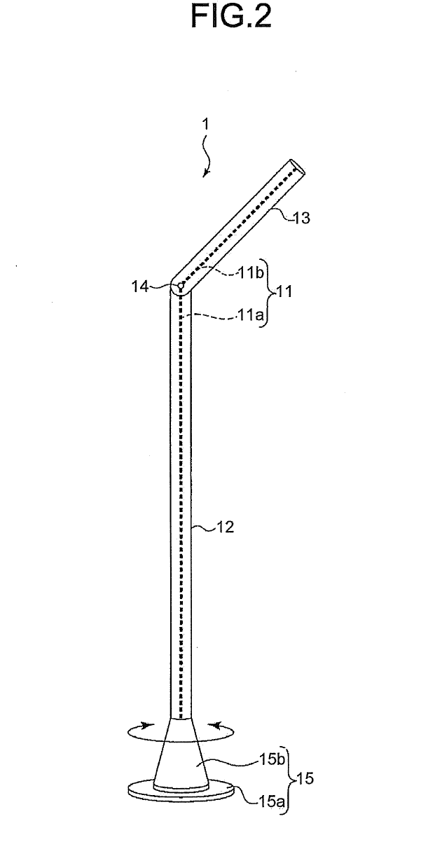

The connecting unit 14 connects the end of the first housing 12 with the end of the second housing 13. The connecting unit 14 has a configuration of pivotally supporting the second housing 13 relative to the first housing 12, and can selectively form multiple states including at least the first state under which the first housing 12 and the second housing 13 are arranges in series as shown in FIG. 1, as well as the second state under which the second housing 13 slopes relative to the first housing 12 as shown in FIG. 2. There are various sorts of known units having above-mentioned functions, and such well-known units can be used as the connecting unit 14.

The supporting table 15 comprises a base portion 15a and a retention portion 15b. The bottom surface of the base portion 15a is flat, and this bottom surface contacts with the floor face at the installation site of the antenna apparatus 1. Retention portion 15b is located above the base portion 15a, and retains the end of the first housing 12 in a manner of the longitudinal direction of the first housing 12 facing the direction approximately perpendicular to the bottom surface of the base portion 15a. The retention portion 15b pivotally supports the periphery of the shaft being along the direction approximately perpendicular to the bottom surface of the base portion 15a in a manner of being able to rotate relative to the base portion 15a as shown by an arrow in FIG. 1 and FIG. 2.

The movements of the antenna apparatus 1 configured as above are described.

For the LCX 11, there are some products having a variety of properties, these products may be used as will. In addition, the products having the properties required by the LCX 11 may be made newly. In addition, the length of the LCX 11 may be any length.

As one example, the LCX 11 is made to a backfire type that radiates radio wave to the feeding side in a manner of sloping at about 20° relative to the longitudinal direction. Then, power is fed from the end of supporting table 15 to the LCX 11. In addition, the length of the LCX 11 is set to 70 cm.

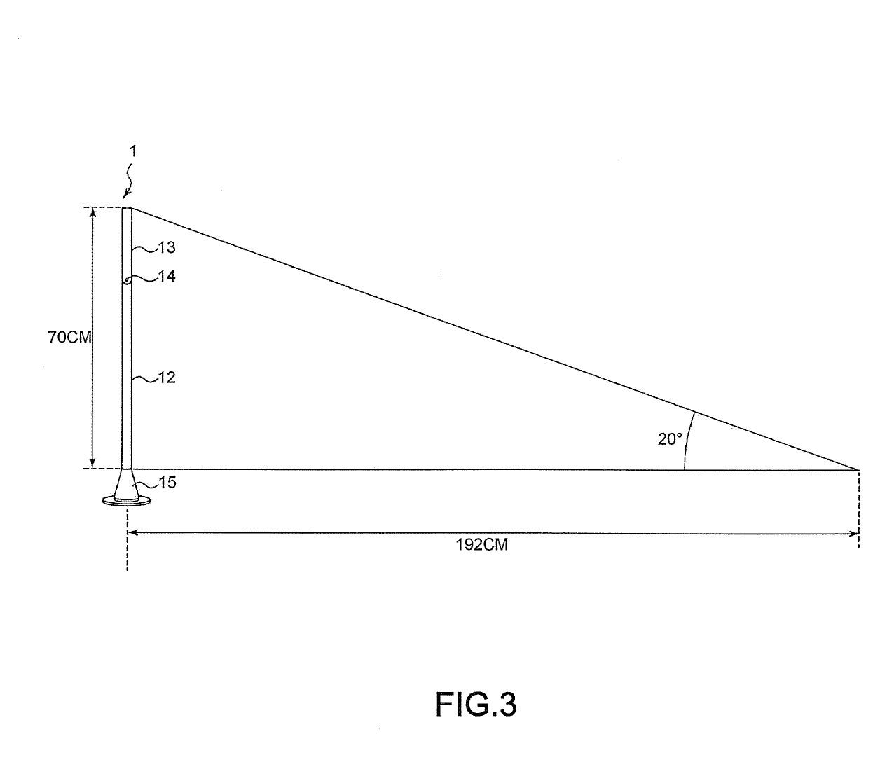

Under such a condition, when the antenna apparatus 1 is under the first state, the location reached by the radio wave radiated from an upper end of the LCX 11 is the location 192 cm apart from a lower end of the LCX 11 in a horizontal direction as shown in FIG. 3. Thereby, a range that centers on the installation position of the antenna apparatus 1 and the radius is about 2 m becomes the communication range.

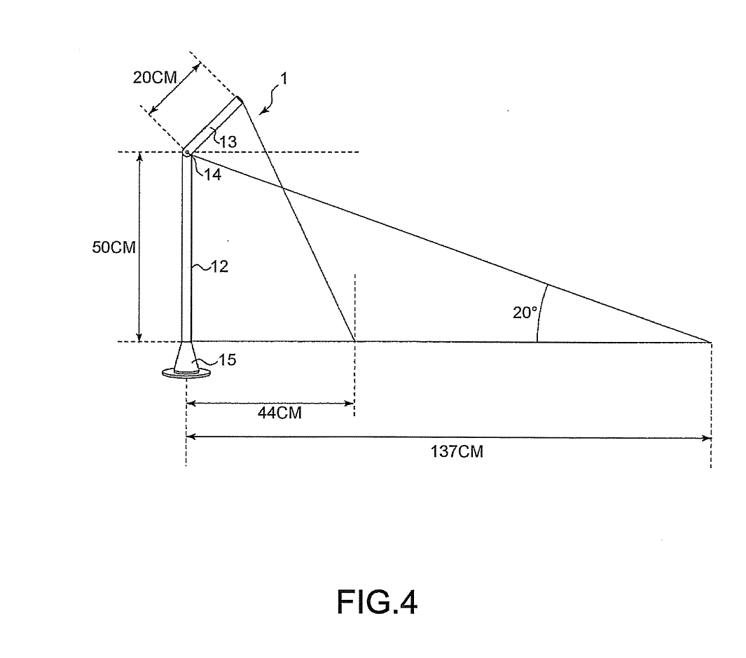

When the antenna apparatus 1 is under the second state, if the lengths of the first region 11a and the second region 11b of the LCX 11 are respectively 50 and 20 cm and the slope of the second region 11b relative to the first region 11a is 45°, the location reached by the radio wave radiated from the upper end of the LCX 11 is, as shown in FIG. 4, the location 44 cm apart from the lower end of the LCX 11 in a horizontal direction. On the other hand, the location reached by the radio wave radiated from the upper end of the second region 11b is, as shown in FIG. 4, the location 137 cm apart from the lower end of the LCX 11 in the horizontal direction. Thereby, a range that centers on the installation position of the antenna apparatus 1 and the radius is about 1.4 m becomes the communication area.

According to such antenna apparatus 1, the direction of the second housing 13 relative to the first housing 12 can be altered, and the dimension of the communication area can be easily altered by altering this direction.

When the antenna apparatus 1 is under the second state, the radio waves respectively radiated from the first region 11a and the second region 11b repetitively reach, thus a part of the communication area will become a null area in which the communication becomes unstable.

The antenna apparatus 1 can alter the position, where the null area is formed, by rotating the retention portion 15b. Thereby, the antenna apparatus 1 can be adjusted such that the null area is formed at the position where the frequency of communication being carried out is relatively low, and the decreased convenience due to formation of the null area can be suppressed.

When the antenna apparatus 1 is under the second state, a radio wave is radiated upwards from the second region 11b, thus a reflected wave is formed at a ceiling, and it is likely to cause the instability of the communication.

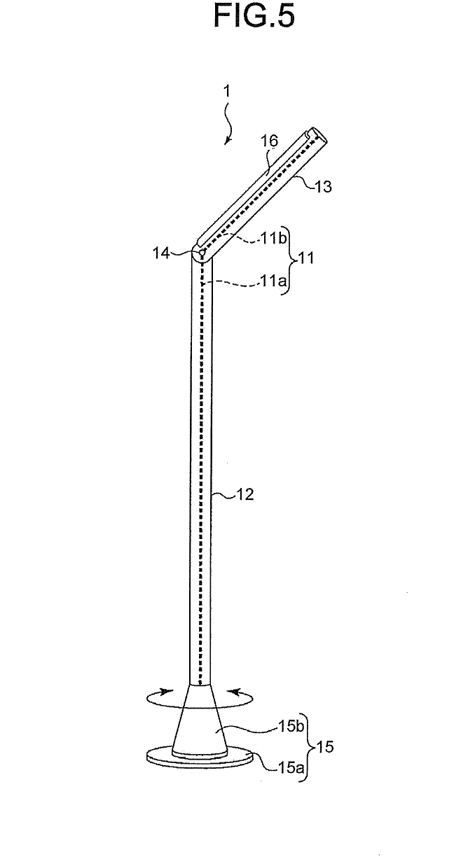

For example as shown in FIG. 5, a shielding member 16 may be installed at the portion facing an upside of an outer surface of the second housing 13. The shielding member 16 is composed of a member that absorbs or reflects the radio wave, and shields the radio wave radiated from the second region 11b. The shielding member 16 may fully shield the radio wave radiated from the second region 11b, and may also reduce it.

If the shielding member 16 is installed on the second housing 13 only under the second state, the communication instability due to the reflected wave at the ceiling mentioned above can be prevented.

Various variation as follow can be made to the embodiment.

The direction of the second housing 13 relative to the first housing 12 may adopt more than one different states. In this way, the dimension of the communication area can be altered via more steps, and a fine adjustment can be made according to needs.

LCX 11 may be arranged in an absolutely linear fashion, and also in a wavelike fashion in part or in whole.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna apparatus, comprising:
a leaky coaxial cable;
a first housing configured to retain a part of one end of the leaky coaxial cable;
a second housing configured to retain a part of other end of the leaky coaxial cable; and
a connecting unit configured to connect the first housing with the second housing such that the direction of the second housing relative to the first housing can be alerted.

2. The antenna apparatus according to claim 1, further comprising:
a supporting table configured to rotatably support the end which is not connected with the second housing of the first housing.

3. The antenna apparatus according to claim 2, wherein
the supporting table supports the first housing at an orientation in which the region retained by the first housing of the leaky coaxial cable is along a vertical direction.

4. The antenna apparatus according to claim 1, further comprising:
a shielding member which is removable on a part of the second housing and shields an electromagnetic wave radiated from a region retain by the second housing of the leaky coaxial cable.

5. The antenna apparatus according to claim 1, wherein
the first housing retains a part of the leaky coaxial cable so as to be straight line.

6. The antenna apparatus according to claim 1, wherein
the second housing retains a part of the leaky coaxial cable so as to be straight line.
